(19) United States
(12) Patent Application Publication
(10) Pub. No.: US 2008/0017002 A1
(43) Pub. Date: Jan. 24, 2008

(54) Apparatus for cutting sheet material

(75) Inventor: Vincent T. Kozyrski, Plainville, CT (US)

Correspondence Address: O'SHEA, GETZ & KOSAKOWSKI, P.C., 1500 MAIN ST., SUITE 912, SPRINGFIELD, MA, 01115, US

(73) Assignee: The Fletcher-Terry Company, Farmington, CT (US)

(21) Appl. No.: 11/491,164

(22) Filed: Jul. 21, 2006

(51) Int. Cl. B26D 7/02

(52) U.S. Cl. 83/455; 83/495

(57) ABSTRACT

An apparatus for cutting a workpiece sheet is provided that includes a support frame, a cutter head assembly, and a clamp assembly. The cutter head assembly is mounted on a track attached to the support frame, and can be selectively moved along the track. The clamp assembly includes a bar that is selectively operable between a retracted position and a deployed position.

### BACKGROUND OF THE INVENTION

1. Technical Field

This invention relates to semi-rigid sheet material cutting devices in general, and to semi-rigid sheet material cutting devices that include clamping devices and the ability to cut a variety of different material types in particular.

2. Background Information

There are numerous devices known to the public relating to sheet material cutters that utilize a cutter head operable to move linearly across a workpiece in sheet form. The existing devices suffer from various shortcomings including, limited or no ability to clamp a workpiece, substantial limitations regarding the types of sheet materials that can be cut, or a lack of fine positional adjustability. In short, the sheet material cutting devices currently known to the public possess shortcomings that affect the performance of the devices.

What is needed is a device that can cut a variety of different types of workpiece materials, one that effectively clamps the workpiece, and one that possesses desirable adjustability.

### DISCLOSURE OF THE INVENTION

According to the present invention, an apparatus for cutting a workpiece sheet is provided that includes a support frame, a cutter head assembly, and a clamp assembly. The cutter head assembly is mounted on a track attached to the support frame, and can be selectively moved along the track. The clamp assembly includes a bar that is selectively operable between a retracted position and a deployed position. Some embodiments of the apparatus include a cutter head assembly that utilizes a statically mounted cutting blade. Other embodiments of the apparatus utilize a cutter head assembly that has a plurality of rotary cutter wheels.

The present apparatus for cutting a workpiece sheet provides numerous advantages over the cutting apparatus currently available. For example, in certain embodiments the cutter head assembly has rotary cutter wheels that are attached to opposite sides of the cartridge. In these embodiments, the cutter head assembly decreases the possibility that the workpiece will bind during the cutting process by efficiently cutting the workpiece and separating the cut portions. Separation of the workpieces is facilitated by the asymmetrical cutter wheels. The ability of the present apparatus to cut sheet material without binding is further improved in those embodiments where the cartridge includes workpiece channels disposed on each side of the cartridge. The depth of each workpiece channel is chosen to substantially align with the cutting edge of the rotary cutter wheel disposed on that side of the cartridge, thereby providing material guidance almost immediately aft of the cutter. The opposite side cutter wheel arrangement also permits similar rotary cutter wheels to be arranged so that the cutting edges radially overlap without having to cantilever one of the cutter wheels a greater distance out from support. The shorter axle distances make the rotary cutter wheel axles less susceptible to deflection, which also helps prevent binding. The opposite side cutter wheel arrangement also results in a uniform load distribution on the cartridge, as opposed to the one-sided loading that occurs in a cutter having a pair of cutter wheels disposed on one side of the cartridge. The uniform load distribution decreases the chance that the cartridge will skew relative to the work piece and bind during the cutting process.

Another advantage provided by the present apparatus for cutting a workpiece sheet is versatility. The cutter head assembly of the present apparatus is operable to mount a plurality of different cutter cartridges, including cartridges having a static cutting blade and cartridges having rotary cutting wheels. As a result, the present apparatus can cut a wide variety of different sheet materials with a single cutter head assembly.

Another advantage provided by the present apparatus is the adjustability provided by a squaring mechanism. The triangular wedge of the squaring mechanism provides much finer adjustability than is possible with adjustment accomplished, for example, by a threaded bolt alone.

Another advantage provided by the present apparatus is that the clamp assembly self-maintains in a deployed position. Consequently, after the clamp assembly is deployed, the operator is free to use both hands to perform other functions; e.g., use both hands to pull the cutter head assembly across the workpiece. Alternatively, if the operator desires to use only slight pressure in clamping the workpiece the clamp assembly can be actuated by hand without utilizing the detented deployed position.

### BRIEF DESCRIPTION OF THE DRAWINGS

FIG. 1 is a planar view of the present device for cutting sheet material.

FIG. 2 is a side view of the present device for cutting sheet material.

FIG. 3A is a sectional view of the vertical frame assembly along section line 3-3, showing the clamp bar in a retracted position.

FIG. 3B is a sectional view of the vertical frame assembly along section line 3-3, showing the clamp bar in a deployed position.

FIG. 4A is a diagrammatic side view of the vertical frame assembly, illustrating the clamp assembly with the clamp bar in a retracted position.

FIG. 4B is a diagrammatic side view of the vertical frame assembly, illustrating the clamp assembly with the clamp bar in a deployed position.

FIG. 5A is a planar top view of the biasing assembly.

FIG. 5B is a planar side view of the biasing assembly.

FIG. 6 is a sectional view of the horizontal frame assembly cut along section line 6-6.

FIG. 7 is a sectional view of the horizontal frame assembly cut along section line 7-7.

FIG. 8 is a partial planar view of the horizontal frame assembly, including the squaring mechanism.

FIG. 9A is a planar view of the cutter head assembly with a glass scoring cartridge embodiment inserted, with the cartridge and arm in the lifted/retracted position.

FIG. 9B is a planar view of the cutter head assembly with a glass scoring cartridge embodiment inserted, with the cartridge and arm in the depolyed position.

FIG. 10A is a top view of the cutter head assembly with a rotary cutter wheel cartridge inserted.

FIG. 10B is a side view of the cutter head assembly with a rotary cutter wheel cartridge inserted.

FIG. 10C is an end view of the cutter head assembly with a rotary cutter wheel cartridge inserted.

FIG. 11 is a planar view of a cartridge embodiment with a static cutting blade.

FIG. 12 is a planar view of a cartridge embodiment with a glass scoring wheel.

FIG. 13 is a planar view of a cartridge embodiment with a pair of rotary cutting wheels.

FIG. 14 is an end view of the cartridge shown in FIG. 13.

FIG. 15 is a diagrammatic sectional view of a rotary cutter wheel embodiment.

FIG. 16 is a diagrammatic sectional view of a rotary cutter wheel embodiment.

FIG. 17 is a diagrammatic sectional view of a rotary cutter wheel embodiment, illustrating deflection of the cutter wheels with force F applied.

### DETAILED DESCRIPTION OF THE INVENTION

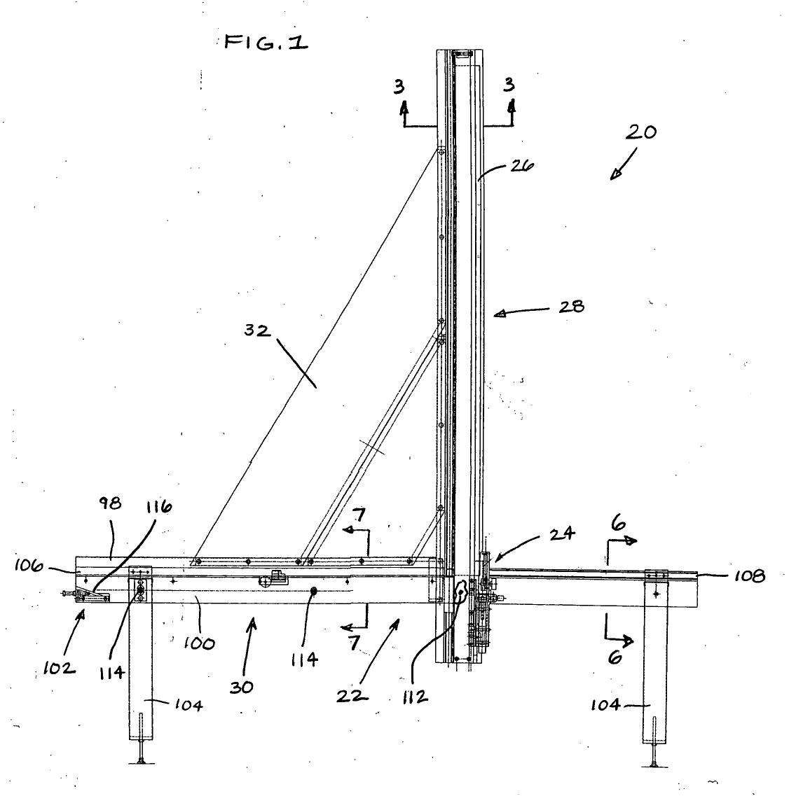

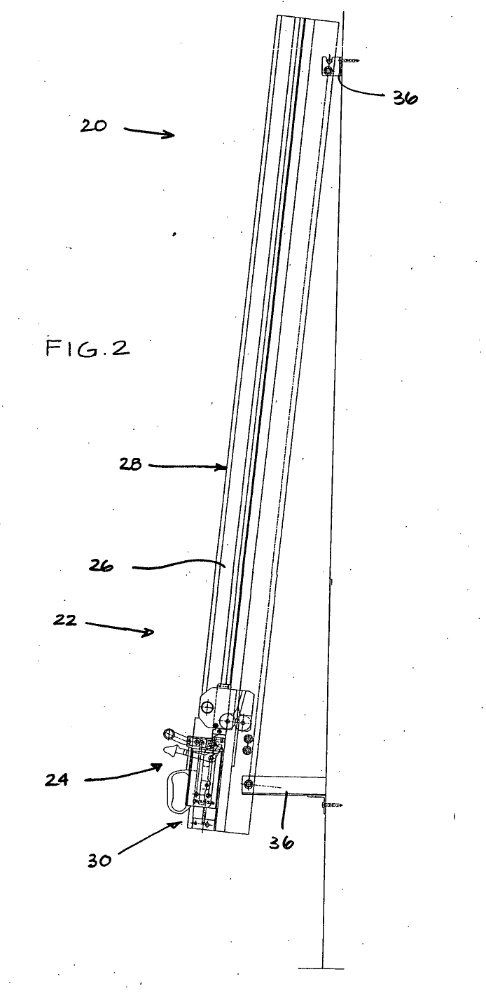

Referring to FIGS. 1 and 2, a device 20 for cutting sheet material is shown that includes a support frame assembly 22 and a cutter head assembly 24 operable to selectively move along a track 26 attached to the support frame assembly 22. The support frame assembly 22 includes a vertical frame assembly 28, a horizontal frame assembly 30, and one or more support panels 32 extending therebetween.

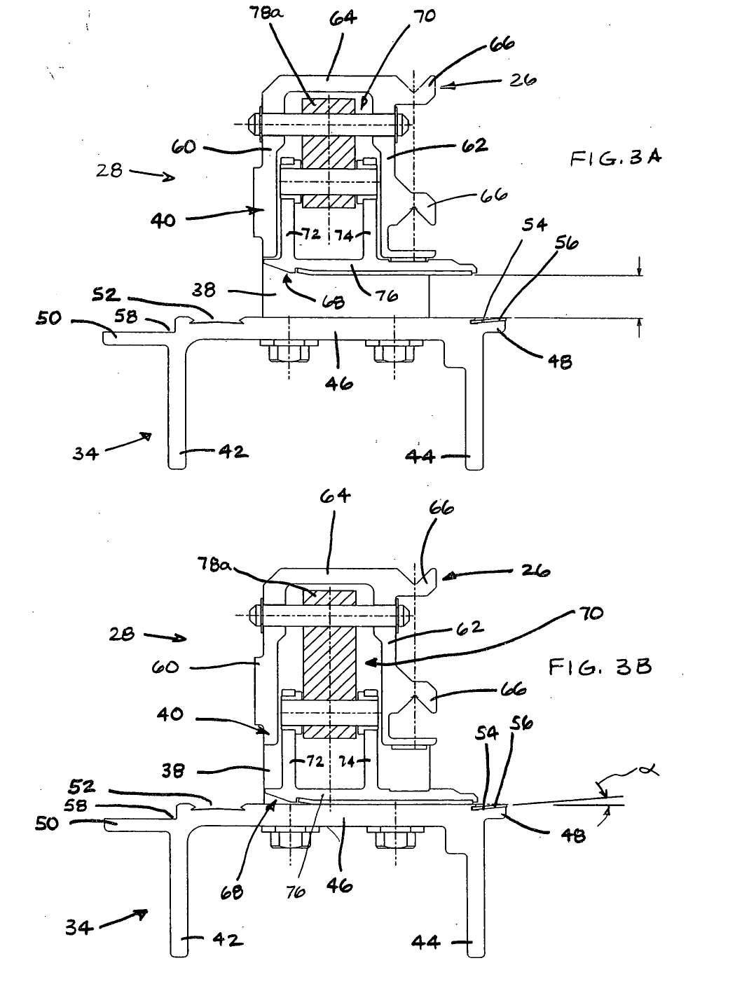

Referring to FIGS. 3A and 3B, the vertical frame assembly 28 includes a vertical frame member 34, a cutter head track 26, a plurality of track spacers 38, and a clamp assembly 40. The term “vertical” as used herein means that the vertical frame assembly 28 is oriented generally perpendicular to the horizontal frame assembly 30 when the device 20 is assembled. In the detailed description provided herein, the vertical frame member 34 is described and shown as being substantially vertical. The device 20 may, however, be positionally oriented otherwise.

The vertical frame member 34 includes a first leg 42, a second leg 44, a web 46 extending between the first and second legs 42, 44, a break-side flange 48, and a panel-side flange 50. In a preferred embodiment, the vertical frame member 34 has a substantially constant cross-section that permits the member 34 to be extruded. The first and second legs 42, 44 extend outwardly from the web 46. The web 46 includes a channel 52 sized to receive a linear rule. Mounting brackets 36 (see FIG. 2) are used to attach the vertical frame member 34 to a wall or other structure (e.g., a stand). The distance between the vertical frame member 34 and the wall or other structure, can be adjusted to tilt the device 20 to a desired vertical orientation. In some embodiments, the break-side flange 48 includes a channel 54 for receiving a hardened strip insert 56 to protect the break-side flange 48. In a preferred embodiment, the channel 54 is disposed at an angle “α” relative to the web 46 such that an edge of the hardened strip insert 56 is approximately coplanar with the outer surface of the web 46. The hardened strip insert 56 may be secured within the channel 54 by a variety of different mechanisms including tape, adhesive, conventional fastener, etc. The panel-side flange 50 includes a stepped portion 58 for attachment to one or more support panels 32 as will be described below.

The cutter head track 26 is attached to the vertical frame member 34 via spacers 38. The track 26 extends approximately parallel to the vertical frame member 34. Two or more track spacers 38 are disposed between the vertical frame member 34 and the track 26 to space the track 26 apart from, and mount the track 26 to, the vertical frame member 34. The track 26 includes a first leg 60, a second leg 62, and a web 64 extending between the legs 60, 62 to form a substantially U-shaped cross-sectional geometry having an interior defined by the first leg 60, second leg 62, and web 64. In preferred embodiments, the track 26 has a constant cross-sectional geometry that permits it to be extruded. The track 26 further includes a pair of opposing guide flanges 66 extending outwardly from the second leg 62 for guiding the cutter head assembly 24 as will be described below.

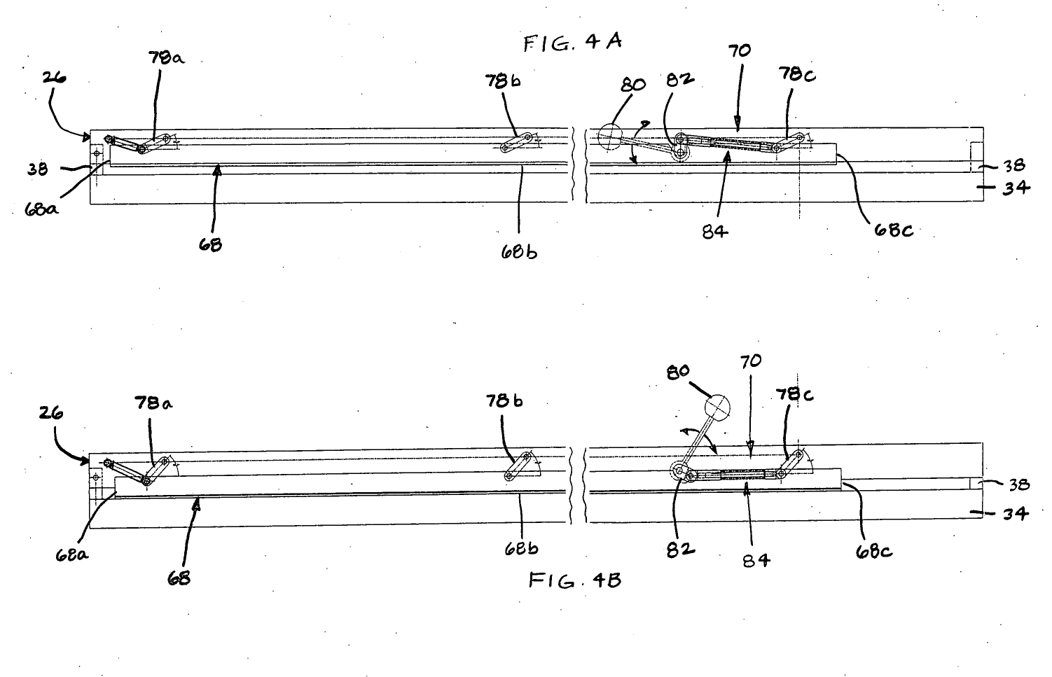

Now referring to FIGS. 3A, 3B, 4A and 4B, the clamp assembly 40 includes a clamp bar 68 and a biasing assembly 70. The clamp bar 68 includes a first leg 72, a second leg 74, and a web 76 extending therebetween and laterally outward from the second leg 74. When assembled, the legs 72, 74 of the clamp bar 68 are received within the interior of the track 26. The clamp bar 68 is attached to the track 26 by a plurality of pivotally mounted links 78a, 78b, 78c that are operable to arcuately pivot the clamp bar 68 between a retracted position adjacent the cutter head track 26, and a deployed position adjacent the vertical frame member 34. The clamp bar 68 remains substantially parallel to the vertical frame member 34 during the travel between the deployed and retracted positions.

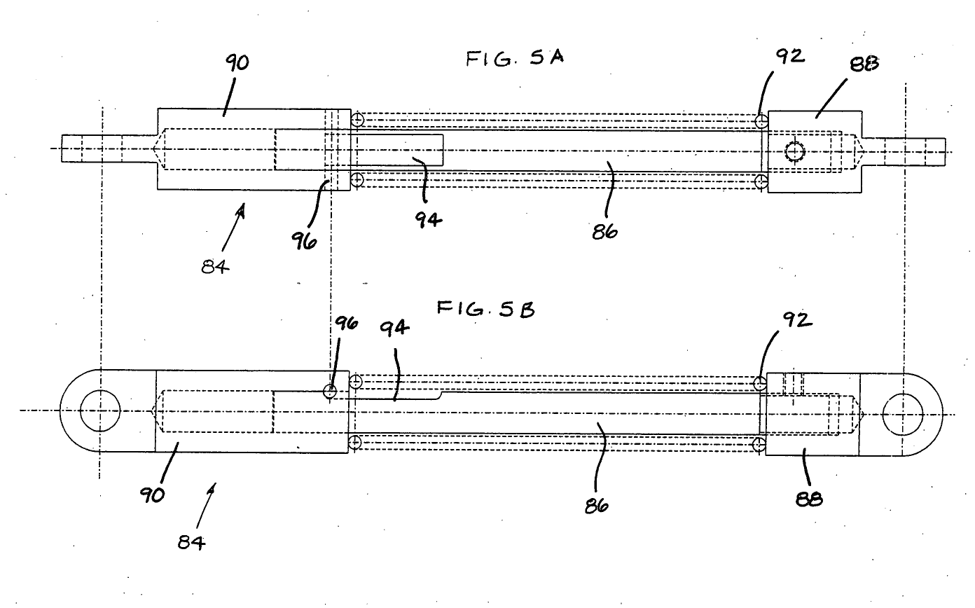

Now referring to FIGS. 4A, 4B, 5A and 5B, the biasing assembly 70 includes a lever 80, a first link 82 fixed to the lever 80, and a biasing member 84. The biasing member 84 includes a rod 86, a first end flange 88, a second end flange 90, and a coil spring 92. The first end flange 88 is attached to a first end of the rod 86. The second end flange 90 is slidably attached to a second end of the rod 86, opposite the first end of the rod 86. The rod 86 includes a slot 94 disposed adjacent the second end of the rod 86, sized to receive a pin 96. The rod 86 is received within the coil spring 92 and within a portion of the second end flange 90. The rod 86 is connected to the second end flange 90 by the pin 96, which extends through the slot 94. The pin 96 allows the rod 86 and the second end flange 90 to move axially relative to one another without disengaging one another. Axial movement between the rod 86 and the second end flange 90 is limited, however, by the pin 96 contacting the two widthwise ends of the slot 94. The coil spring 92 extends between and acts upon the first and second end flanges 88, 90, thereby biasing the first end flange 88 and attached rod 86 away from the second end flange 90; i.e., toward one end of the permissible travel therebetween. The amount of force provided by the biasing member 84 can be altered by changing the coil spring 92 to one having a different spring rate. The second end flange 90 is pivotally attached to the first link 82 and the first end flange 88 is pivotally attached to the clamp bar 68.

The lever 80, link 82, and biasing member 84 can be rotated into a retracted position as shown in FIG. 4A. From the retracted position, the aforesaid elements can be rotated to a position where the first link 82 and biasing member 84 are axially aligned with one another, and rotated further to a deployed position as shown in FIG. 4B. The deployed position is located a specific rotation angle beyond the axial alignment position (sometimes referred to as an “over the center” position) and thereby creates a detent position where the biasing element 84 holds the elements 80, 82, 84 in place. The force applied by clamp bar 68 via the biasing assembly 70 is greatest when the first link 82 and biasing member 84 are axially aligned with one another, and slightly less in the deployed position. When the biasing assembly 70 is in the deployed position (FIG. 4B), a workpiece can be clamped between the clamp bar 68 and the vertical frame member 34. When the biasing assembly 70 is in the retracted position (FIG. 4A), the clamp bar 68 is disposed in a retracted position away from the workpiece and therefore the vertical frame member 34.

In some embodiments, the clamp bar 68 may be slightly crowned in the middle region 68b between ends 68a, 68c. The crown can be created, for example, by a slight curvature of the clamp bar 68, or by a thicker web 76 in the middle region 68b, etc. Alternatively, the crown can be created by causing the clamp bar 68 to deflect slightly in the middle; e.g., by using a link 78b in the middle that is slightly longer than the links 78a, 78c disposed near the end of the clamp bar 68.

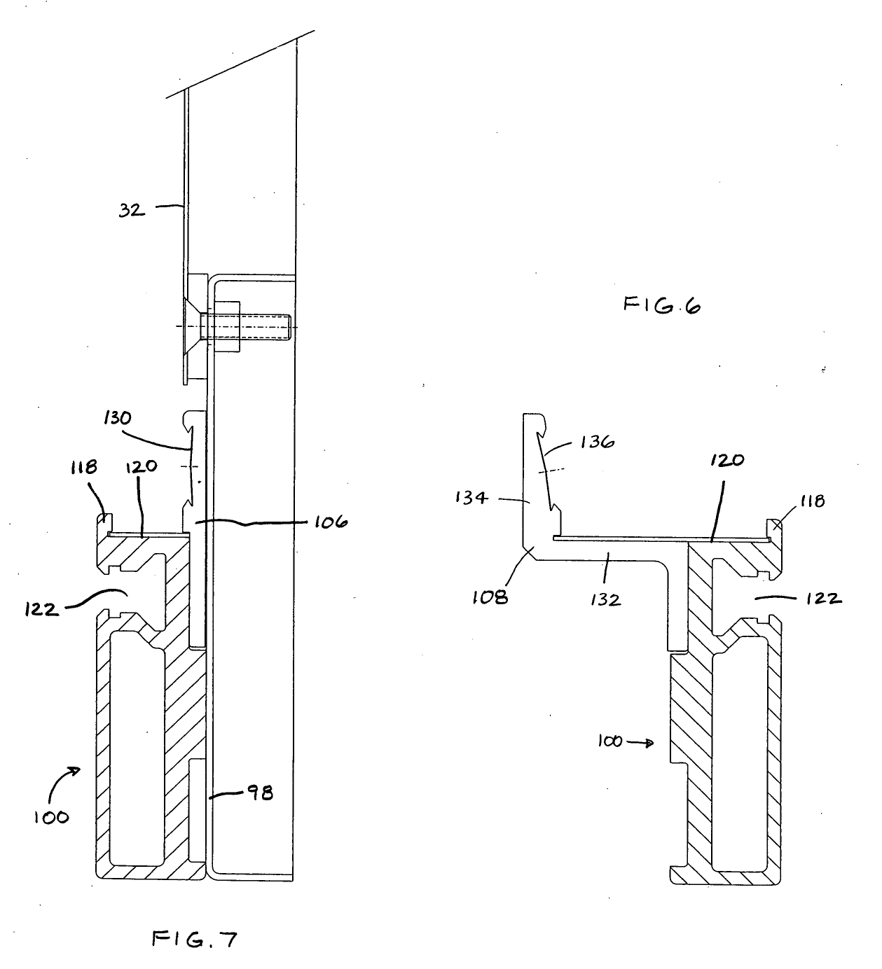

Now referring to FIGS. 1 and 6-8, the horizontal frame assembly 30 includes a static horizontal frame (SHF) member 98, a pivotal horizontal frame (PHF) member 100, an squaring mechanism 102, one or more support legs 104, a support-side tray member 106, and an exit-side tray member 108. The one or more support legs 104 can be adjusted to change the position of the device 20 relative to the floor. The term “horizontal” as used herein means that the horizontal frame assembly 30 is oriented generally perpendicular to the vertical frame assembly 28 when the device 20 is assembled. In the detailed description provided herein, the horizontal frame assembly is described and shown as being substantially horizontal. The device 20 may be positionally oriented otherwise, however.

The SHF member 98 is a C-shaped member that includes a flange attached to one end for attaching the SHF member 98 to the vertical frame member 34. The one or more support legs 104 are attached to the SHF member 98. The one or more support panels 32 extend between and are attached to the SHF member 98 and the vertical frame member 34.

The PHF member 100 is pivotally attached to vertical frame member 34 at a pivot point 112 (see FIG. 1) and can therefore be selectively pivoted relative to the SHF member 98 and the vertical frame member 34. The PHF member may be a single piece that extends along the entire horizontal frame member 30, or it may be sectioned with one section pivotable relative to the vertical frame member 34. One or more fasteners 114 are provided that are operable to fix the PHF member 100 to the SHF member 98. The fastener 114 may be attached to one of the PHF member 100 or the SHF member 98, and travel through a clearance hole or slot in the other of the SHF member 98 or the PHF member 100 to accommodate the relative travel between the members 98, 100. The PHF member 100 includes a ramp surface 116 disposed at or adjacent one end, and a front lip 118 extending outwardly from a top surface 120. In a preferred embodiment, the PHF member 100 has a constant cross-section that permits it to be extruded. The PHF member 100 includes a channel 122 for receiving workpiece positional stops.

The support-side tray member 106 attaches to the PHF member 100 on one side (e.g., the left side facing the device 20) of the vertical frame member 34. The support-side tray member 106 extends away from the PHF member 100 in a direction that is substantially parallel to the front lip 118 of the PHF member 100, thereby forming a channel with the front lip 118 and the top surface 120. The support-side tray member 106 may include a slot 130 for receiving a linear rule. The exit-side tray member 108 attaches to the PHF member 100 on the opposite side (e.g., the right side facing the device 20) of the vertical frame member 34. The exit-side tray member 108 includes a first portion 132 that extends away from the PHF member 100 in a direction that is coplanar with the top surface 120 of the PHF member 100, and a second portion 134 that is substantially parallel to the front lip 118 of the PHF member 100 thereby forming a channel with the front lip 118, top surface 120, and first portion 132. The second portion 134 of the exit-side tray member 108 may include a slot 136 for receiving a linear rule.

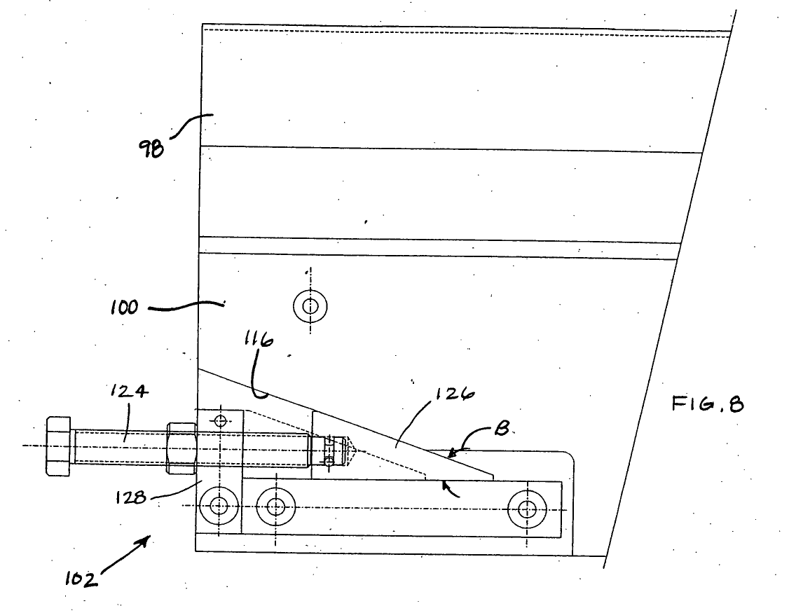

Now referring to FIGS. 1 and 8, the squaring mechanism 102 includes a threaded member 124 pivotally attached to a wedge 126 (e.g., triangular-shaped), and a threaded flange 128. The threaded member 124 is in threaded engagement with the flange 128 (or a nut attached thereto). Rotation of the threaded member 124 is operable to laterally move the wedge 126. The wedge 126 is positioned in contact with the ramp surface 116 of the PHF member 100. Movement of the wedge 126 causes the PHF member 100 to rotate relative to the vertical frame member 34. The rate at which the PHF member 100 rotates relative to the vertical frame member 34 is dictated by the angle “β” of the triangular wedge 126 and the thread per unit length (e.g., coarse thread, fine thread, etc.) of the threaded member 124.

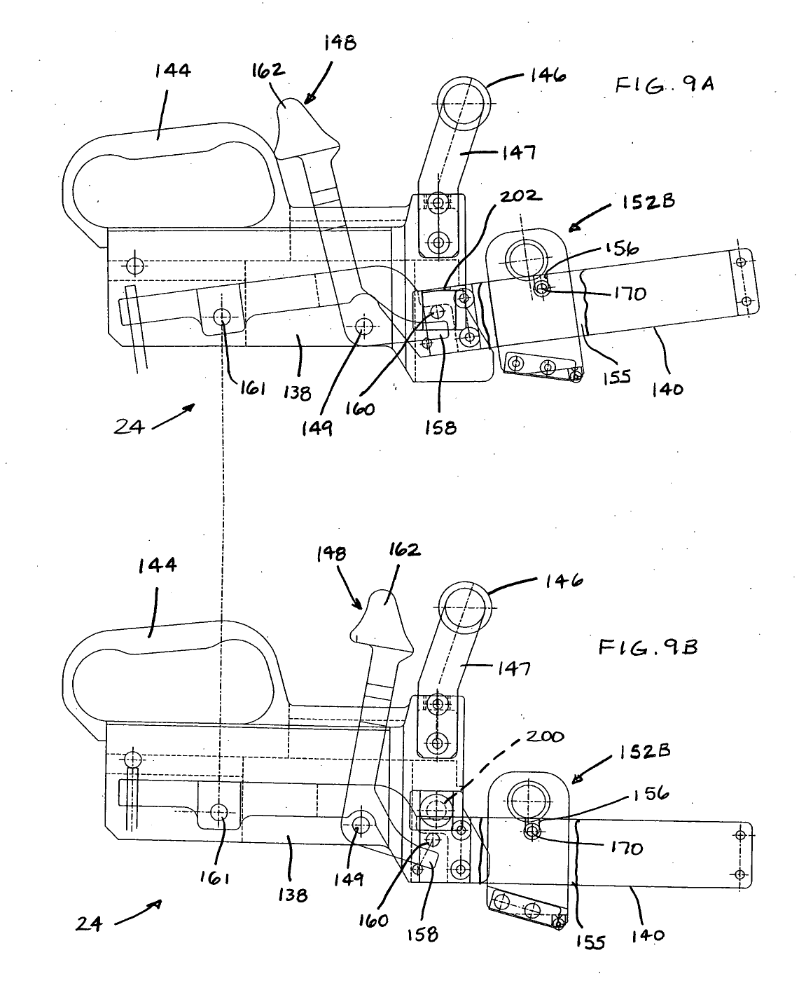

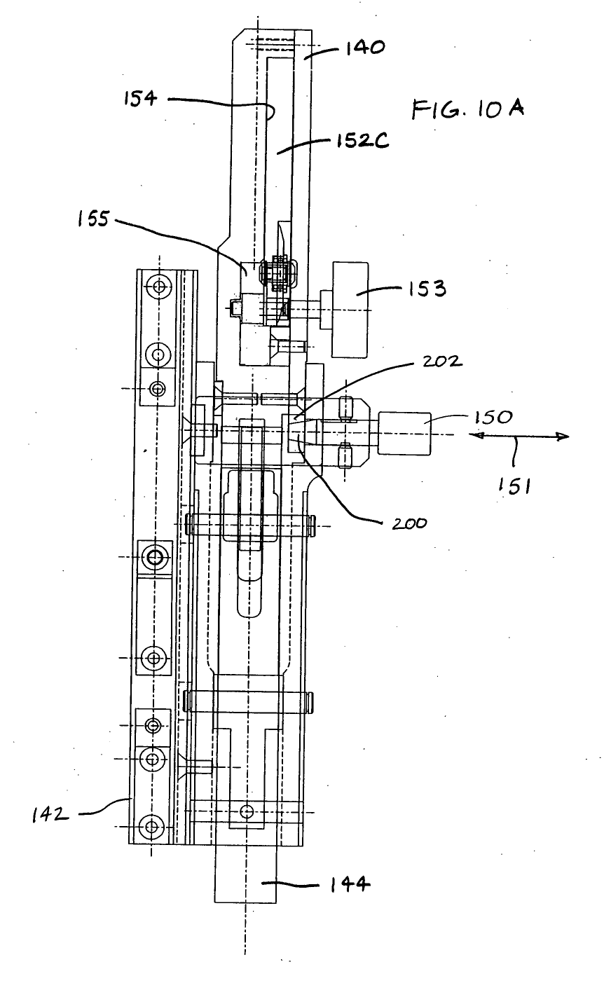

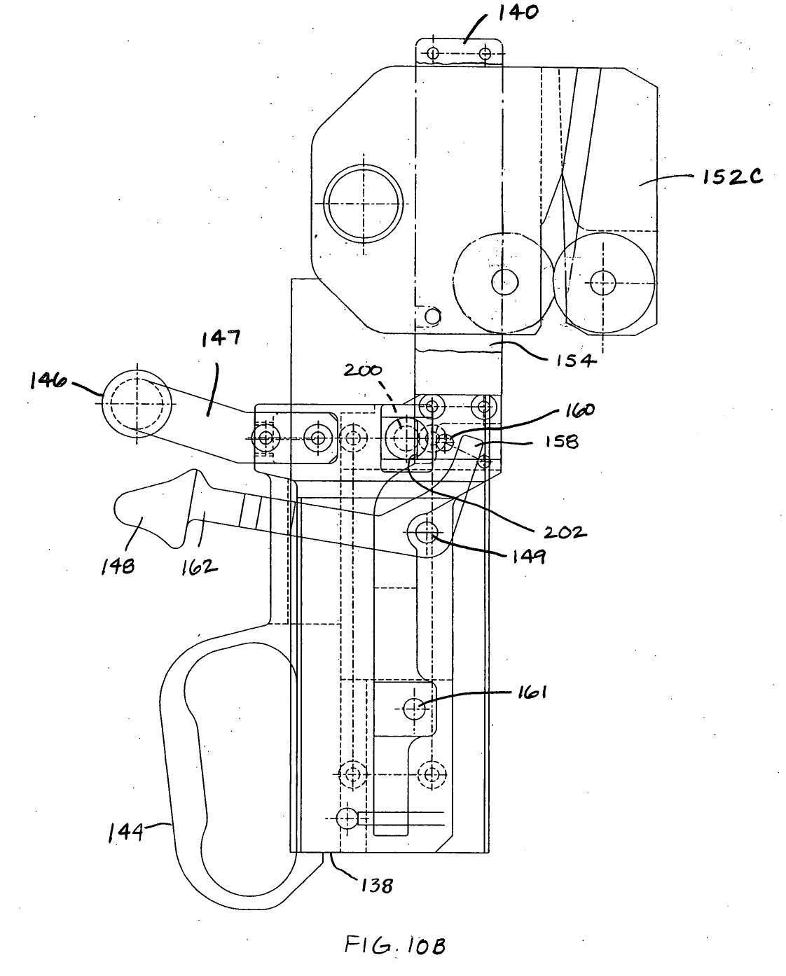

Now referring to FIGS. 9A, 9B, 10A, 10B, and 10C, the cutter head assembly 24 includes a frame 138, a cartridge support arm 140, a track guide 142 (see FIG. 10C), a first handle 144, a second handle 146, a cartridge lift lever 148, a lock screw 153, and a cartridge 152A, 152B, 152C. As will be explained below, there are a variety of different cartridge embodiments that can be used with the cutter head assembly 24. Cartridges 152A, 152B, and 152C represent examples of acceptable cartridges. The first handle 144 is attached to the frame 138. In the embodiment shown in FIGS. 9A, 9B, 10B, and 10C, the first handle 144 is integrally formed with the frame 138. The second handle 146 (not shown in FIG. 10A), which is attached to the frame 138 by a pair of brackets 147, extends laterally outward from the frame 138; i.e., extends out from the frame 138 in a direction that is substantially perpendicular to the travel direction of the cutter head assembly 24. The lock screw 153 (see FIG. 10A), which is threadably engaged with the support arm 140, is operable to selectively fix a cartridge 152A, 152B, 152C within the support arm 140.

The cartridge support arm 140 is pivotally attached to the frame 138 to allow the cartridge 152 to be positioned in a deployed position (FIG. 9B) or a retracted position (FIG. 9A). A spring is disposed within the frame 138 to bias the cartridge support arm 140 in the deployed position. A pin 150 slidably engaged with the frame 138 (along the axis of arrow 151—see FIG. 10A) can be positioned to maintain the cartridge support arm 140 in the deployed position or in the retracted position. In a preferred embodiment, the pin 150 has a tapered portion 200 located at its distal end (see FIG. 10A; also shown in phantom in FIGS. 9B and 10B), and a portion of the support arm 140 has a matching tapered surface 202 (see FIGS. 9A and 10A). The tapered surface 202 of the support arm 140 is positioned to align with the tapered portion 200 of the pin 150 when the support arm 140 is located in the deployed position. FIGS. 9B and 10B diagrammatically shows the tapered portion 200 of the pin 150 engaged with the tapered surface 202 when the support arm 140 is in the deployed position. The tapered surfaces 200,202 facilitate alignment between the pin 150 and the support arm 140, and thereby facilitate engagement of the pin 150 with the support arm 140. The cartridge support arm 140 includes one or more pockets 154, 155 for receiving one or more different cartridges 152A, 152B, 152C. In some embodiments, one or more slots 156 are disposed in the wall of the pocket 154, 155 to receive a locating post 170, 190 as will be explained below.

The cartridge lift lever 148 is pivotally attached to the frame 138. A first end 158 of the lift lever 148 is positioned for engagement with a post 160 attached to the support arm 140. The second end 162 of the lift lever 148 extends toward a position adjacent the first handle 144. If the second end 162 of the lift lever 148 is pulled toward first handle 144, the lift lever 148 will pivot about axle 149 and the first end 158 of the lift lever will contact the post 160. If the lift lever 148 is drawn further toward the first handle 144, the lift lever 148 will cause the cartridge support arm 140 to rotate about axle 161, thereby moving the cartridge support arm 140 into the retracted position. Other mechanisms for pivoting the cartridge support arm 140 may be used alternatively.

Referring to FIG. 10C, the track guide 142 is a C-shaped member that is attached to one side of the frame 138. A pair of opposing guide elements 164 is attached to the interior of the track guide 142. The guide elements 164 are shaped and spaced apart from one another to form a mating pair with the opposing guide flanges 66 extending outwardly from the cutter head track 26. The guide elements 164 form a slide fit with the opposing guide flanges 66 to permit the cutter head assembly 24 to be moved linearly along the cutter head track 26.

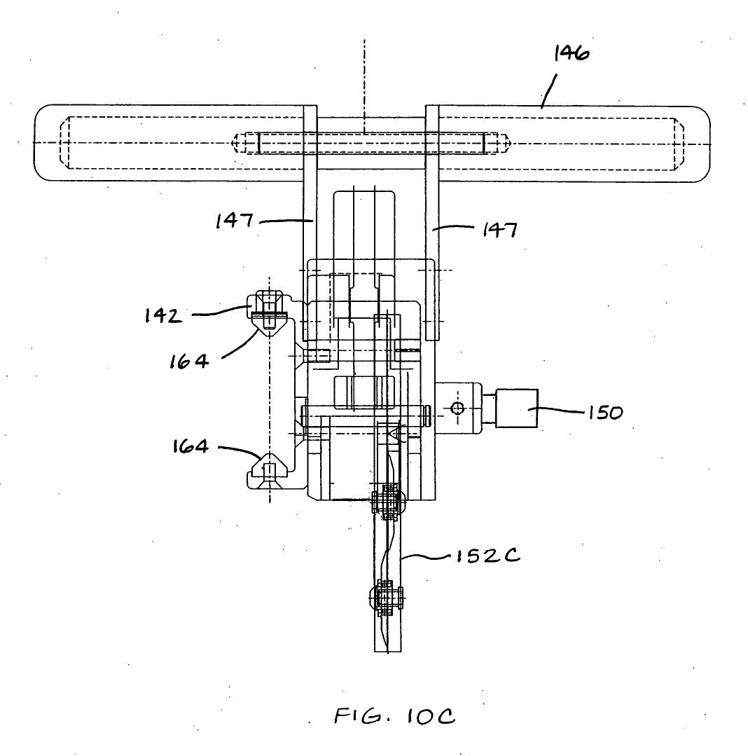

The cartridge can assume a variety of different forms (e.g., 152A, 152B, 152C) operable to cut a variety of different materials. In the embodiment shown in FIG. 11, the cartridge 152A includes a frame 166 and a cutting blade 168 statically mounted relative to the cartridge 152A. The blade 168 is attached to the cartridge 152A in a predetermined position, such that at least a portion of a cutting edge of the blade 168 extends outside the frame 166. The frame 166 includes a locating post 170 attached to the frame 166, extending outwardly from the frame 166. The locating post 170 is positioned to align with the slot 156 disposed in the pocket 155 in the cartridge support arm 140 (see FIGS. 9A and 9B). The locating post 170 and slot 156 ensure the cartridge 152A is properly positioned within the pocket 155, and therefore relative to the cutter head assembly 24.

Now referring to FIG. 12, an alternative cartridge 152B includes a glass scoring wheel 172 pivotally mounted to the frame 167 of the cartridge 152B. In this embodiment, the glass scoring wheel 172 is operable to be placed on a surface of a pane of glass.

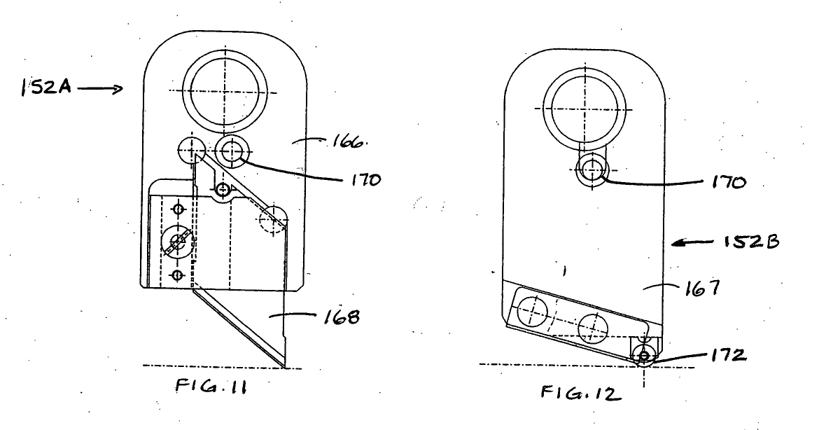

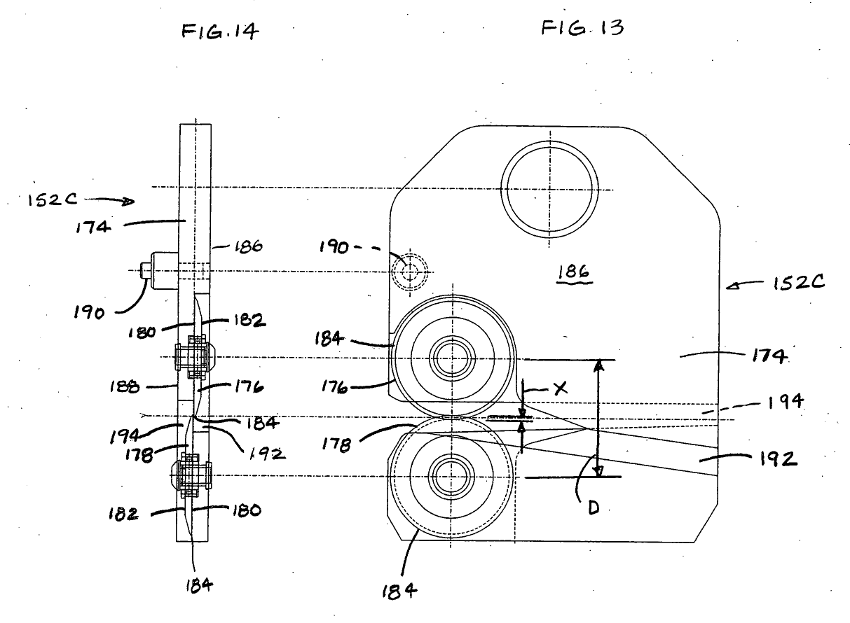

Now referring to FIGS. 13 and 14, in another embodiment, the cartridge 152C includes a frame 174, a first rotary cutter wheel 176, and a second rotary cutter wheel 178. Each cutter wheel 176, 178 has an inner surface 180, an outer surface 182, and a cutting edge 184. The first rotary cutter wheel 176 is disposed on a first side 186 of the frame 174. The second rotary cutter wheel 178 is disposed on a second side 188 of the frame 174 opposite the first side 186. The cutter wheels 176, 178 are mounted on independent axes separated from one another by a predetermined distance “D”. In some embodiments, the distance “D” is chosen to create a radial overlap of magnitude “X” between the cutter wheels 176, 178. The cutter wheels 176, 178 are also spaced on the independent axes to create a lateral separation distance “Y” between cutter wheels 176, 178 (see FIG. 15). The lateral separation distance “Y” can be defined as the distance between chosen similar surfaces of the cutter wheels 176, 178; e.g., the distance between the cutting edges 184, or between the inner surface 180 of each cutter wheel 176, 178, etc. The lateral separation distance “Y” can be accurately created by tolerancing, or shims, etc. Each cutter wheel 176, 178 is preferably mounted on a bearing to facilitate rotation about a defined axis, and minimize wobble of the cutter wheel 176, 178 relative to the axis.

The cartridge frame 174 also includes a locating post 190 attached to the frame 174, extending outwardly from the frame. The locating post 190 is positioned to align with the slot 156 disposed in the pocket 155 within the cartridge support arm 140. The locating post 190 and slot 156 ensure the cartridge 152 is properly positioned within the pocket 154.

The cartridge 152 may further include a first workpiece channel 192 disposed in the first side 186 of the frame 174, and a second workpiece channel 194 disposed in the second side 188 of the frame 174. The workpiece channels 192, 194 are positioned to receive portions of the workpiece sheared by the cutter wheels 176, 178 as will be explained below. The depth of each workpiece channel 192, 194 is chosen such that sheet material portion exiting the cutter wheels 176, 178 readily passes into the workpiece channel 192, 194.

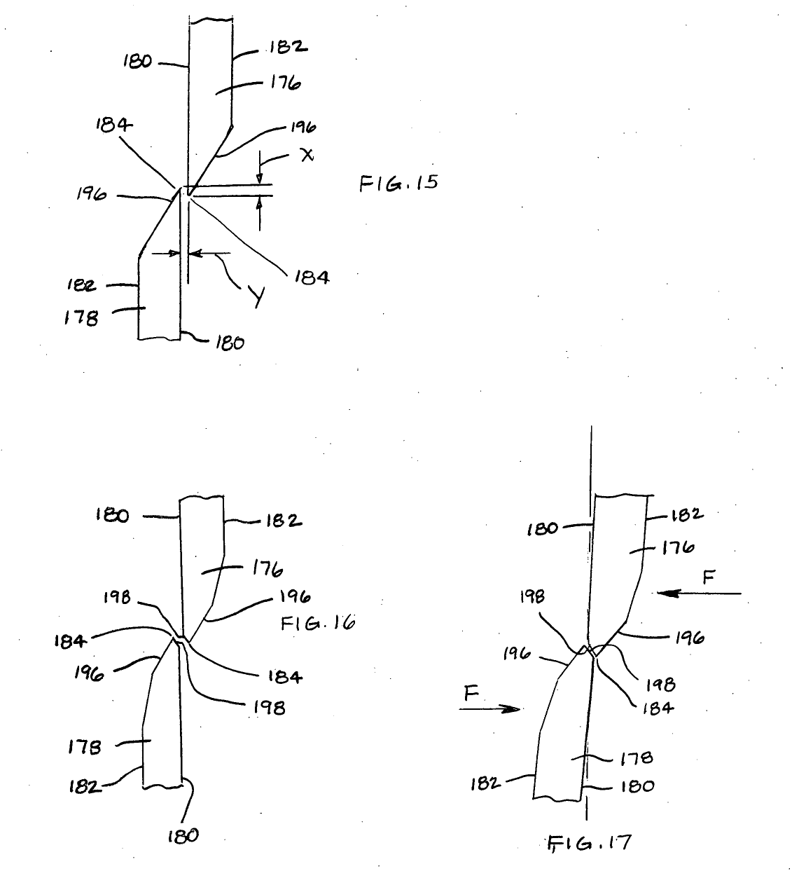

Referring to FIGS. 15-17, the cutting edge 184 of a cutter wheel 176, 178 is defined by one or more surfaces that collectively extend between the inner surface 180 and the outer surface 182. For example, the cutting edge 184 may be defined by a single edge surface 196 (see FIG. 15) that extends between the inner and outer surfaces 180, 182. Alternatively, the cutting edge 184 may be defined by a first edge surface 196 extending from the outer surface 182 and a second edge surface 198 extending from the inner surface 180 side of the cutter wheel 176, 178. In the embodiment shown in FIGS. 16 and 17, the cutter wheel 176, 178 has an asymmetrical cutting edge 184 defined by the first edge surface 196 and the edge second surface 198. The first edge surface 196 is substantially longer than the second edge surface 198, and the cutting edge 184 is disposed closer to the inner surface 180 than the outer surface 182. The second edge surface 198 may be formed by machining (e.g., grinding, cutting, etc.) a slight relief surface. For example, a second edge surface 198 can be formed by honing a 5° angle, laterally positioned to create a second edge surface 198 with a length between 0.010 and 0.015 inches. The diagrammatic views of FIGS. 16 and 17 are exaggerated to better illustrate the cutting edge embodiments. The cutting edge 184 is not limited to these exemplary embodiments.

Now referring to FIGS. 16 and 17, one of the advantages provided by the cutter wheel embodiment having a first edge surface 196 and a second edge surface 198 is that it desirably decreases the tendency of cutter wheels 176, 178 to bind with one another when cutting certain materials such as metals, etc. Materials being cut in the rotary cutter wheel embodiment of the cartridge 152C (e.g., as seen in FIGS. 13 and 14) impart a force “F” to the outer surface 182 of the cutter wheels 176, 178 that forces the wheels toward one another. Depending upon the magnitude of that force and the lateral separation distance “Y” between the cutter wheels 176, 178, the wheels can bind with one another. If the force is great enough, the cutter wheels can damage one another. The inclusion of the second cutting edge 198 in the cutter wheels 176, 178, as shown in FIGS. 16 and 17, helps to decrease or eliminate interference between the cutter wheels 176, 178, and thereby decrease or eliminate undesirable binding. FIG. 17 diagrammatically illustrates a pair of cutter wheels 176, 178, deflecting toward one another under lateral forces F. The second cutting edges 198 permit the cutting wheels 176, 178 to draw closer to one another than would be possible otherwise without interference occurring.

The following examples are provided to illustrate the utility of the present device 20 for cutting sheet material.

### EXAMPLE I

The present device 20 for cutting sheet materials can be used for cutting mat board commonly used in the process of picture framing. The device 20 is mounted against a wall surface (or independently via a stand) at an appropriate work height and angle by adjusting the bracketry and support leg 104. The angle between the PHF member 100 and the vertical frame member 34 is adjusted by actuating the squaring mechanism 102. For example, a squaring mechanism 102 having a wedge 126 with a ramp angle of approximately 20 degrees, and a threaded member 124 having ⅜ inch—24 UNF thread, will provide a vertical change of approximately 0.015 inches per revolution of the threaded member 124. The magnitude of the change in angle of the workpiece relative to the cutter head track 26 will, however, depend on the position of the squaring mechanism 102 relative to the pivot point 112 of the PHF member 100. The cutter head assembly 24 can be positioned to permit a matboard to be inserted into the device 20 by moving the assembly 24 along the track 26 to an upper position.

Once the PHF member 100 and the vertical frame member 34 are square with one another and the cutter head assembly 24 is located out of the way, the matboard is inserted between the clamp bar 68 and the vertical frame member 34. The matboard can be positioned relative to the cutter head assembly 24 using the linear rules provided in the support-side tray member 106, the exit-side tray member 108, and/or the vertical frame member 34.

With the matboard properly positioned, the clamp assembly 40 is actuated from the retracted position to the deployed position. In the deployed position, the biasing assembly 70 biases and maintains the clamp bar 68 in contact with the matboard, thereby clamping it against the vertical frame member 34. The matboard will remain clamped without further action from the operator until the clamp assembly 40 is actuated into the retracted position (i.e., the operator himself is not required to maintain clamp pressure).

In this example, the cutter head assembly 24 utilizes the cartridge 152A having a statically mounted cutting blade 168. The cutter head assembly 24 is moved so that the cutting blade 168 contacts the matboard, and then is subsequently drawn across the matboard to perform the cut. Once the cut is made, the cutter head assembly 24 is secured out of the way, the clamping assembly 40 is actuated into a retracted position, and the matboard is removed from the device 20.

Examples of other sheet materials that can be cut with the present device 20 using a cartridge 152A with a static cutting blade 168, include PVC, foamboard, wood veneer, corrugated vinyl, etc.

### EXAMPLE II

The present device 20 for cutting sheet materials can be used to cut diebond (i.e., corrugated panels including outer layers consisting of sheet metal), which is commonly used for signage. The device 20 is mounted similar to the manner described above under Example I.

Once the PHF member 100 and the vertical frame member 34 are square with one another and the cutter head assembly 24 is located out of the way, the diebond sheet is inserted between the clamp bar 68 and the vertical frame member 34. The diebond sheet can be positioned relative to the cutter head assembly 24 using the linear rules provided in the support-side tray member 106, the exit-side tray member 108, and/or the vertical frame member 34. With the diebond sheet properly positioned, the clamp assembly 40 is actuated from the retracted position to the deployed position. In the deployed position, the biasing assembly 70 biases and maintains the clamp bar 68 in contact with the diebond, thereby clamping it against the vertical frame member 34.

In this example, the cutter head assembly 24 utilizes the cartridge 152C having rotary cutter wheels 176, 178. The cutter head assembly 24 is moved so that the diebond sheet is drawn between the rotary cutter wheels 176, 178 and the assembly 24 is subsequently drawn across the diebond sheet to perform the cut. As the diebond sheet passes through the rotary cutter wheels 176, 178, one of cut sheet portions is guided within the first workpiece channel 192 in a first direction and the other cut sheet portion is guided within the second workpiece channel 194 in a second direction away from the first direction. Once the cut is made, the cutter head assembly 24 is secured out of the way, the clamping assembly 40 is actuated into a retracted position, and the diebond sheet is removed from the device 20.

Examples of other sheet materials that can be cut with the present device 20 using a cartridge 152C with rotary cutter wheels 176,178 include sheet metal, alumalite, etc.

Although this invention has been shown and described with respect to the detailed embodiments thereof, it will be understood by those skilled in the art that various changes in form and detail thereof may be made without departing from the spirit and the scope of the invention.

What is claimed is:

1. An apparatus for cutting a workpiece sheet, comprising:
a vertical frame member;
a cutter head assembly mounted on a track, which track is attached to the vertical frame member, wherein the cutter head assembly can be selectively moved along the track;
a clamp assembly having a bar that is selectively operable between a retracted position and a deployed position, wherein in the deployed position, the clamp bar self-maintains in the deployed position.

2. The apparatus according to claim 1, further comprising:
a pivotable horizontal frame member; and
an squaring mechanism that includes a wedge engaged with the horizontal frame member.

3. The apparatus of claim 1, wherein the clamp assembly further comprises a biasing assembly selectively operable to move a linkage and bar between the retracted and deployed positions.

4. The apparatus of claim 3, wherein the biasing assembly is operable to maintain the bar in the deployed position.

5. The apparatus of claim 3, wherein the bar is crowned in a middle region when the bar is in the deployed position.

6. The apparatus of claim 5, wherein the crown is created by the linkage.

7. The apparatus of claim 1, wherein the cutter head assembly includes a cartridge having a static cutting blade.

8. The apparatus of claim 1, wherein the cutter head assembly includes a cartridge having a plurality of rotary cutter wheels.

9. The apparatus of claim 8, wherein a first rotary cutter wheel is mounted on a first side of a frame of the cartridge and a second rotary cutter wheel is mounted on a second side of the frame, wherein the second side is opposite the first side.

10. The apparatus of claim 9, wherein the first and second rotary cutter wheels each have an asymmetrical cutting edge.

11. The apparatus of claim 10, wherein the first and second rotary cutter wheels each include a first edge surface extending from a cutting edge on an outer surface side of the cutter wheel, and a second edge surface extending from the cutting edge on an inner surface side of the cutter wheel.

12. The apparatus of claim 11, wherein the cutting edge is disposed laterally closer to the inner surface side of the cutter wheel than the outer surface side.

13. The apparatus of claim 11, wherein the first edge surface is longer than the second edge surface.

14. An apparatus for cutting a workpiece sheet, comprising:
a support frame;
a cutter head assembly mounted on a track attached to the support frame, wherein the cutter head assembly includes a cartridge having a frame, a first rotary cutter wheel attached to a first side of the cartridge frame, and a second rotary cutter wheel attached to a second side of the cartridge frame, wherein the second side is opposite the first side, the first and second rotary cutter wheels each include a first edge surface extending from a cutting edge on an outer surface side of the cutter wheel, and a second edge surface extending from the cutting edge on an inner surface side of the cutter wheel;
a clamp assembly having a bar that is selectively operable between a retracted position and a deployed position.

15. The apparatus of claim 14, wherein the cutting edge is disposed laterally closer to the inner surface side of the cutter wheel than the outer surface side.

16. The apparatus of claim 14, wherein the first edge surface is longer than the second edge surface.

17. The apparatus of claim 14 wherein the cartridge includes a first workpiece channel disposed in the first side of the cartridge frame, and a second workpiece channel disposed in the second side of the cartridge frame.

18. The apparatus of claim 14, wherein the cutter head assembly includes a pivotally mounted cartridge support arm having a pocket for receiving the cartridge, wherein the cartridge support arm is operable to be selectively pivoted to move the cartridge toward or away from the workpiece sheet.

20. The apparatus of claim 14, wherein the support frame comprises a vertical frame assembly and a horizontal frame assembly, the horizontal frame assembly including a frame member pivotally mounted to the vertical frame assembly.

21. The apparatus of claim 20, further including a squaring mechanism operable to pivot the frame member relative to the vertical frame assembly.

22. The apparatus of claim 21, wherein the squaring mechanism includes a laterally movable wedge.
